(19) United States
(12) Patent Application Publication
(10) Pub. No.: US 2013/0016074 A1
(43) Pub. Date: Jan. 17, 2013

(54) ELECTRONIC DEVICE

(71) Applicant: PENG WANG, Shenzhen City (CN)

(72) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/221,911

(22) Filed: Aug. 31, 2011

(30) Foreign Application Priority Data
Jul. 11, 2011 (CN) 201110192789.1

(51) Int. Cl. G09G 5/00

(52) U.S. Cl. 345/184

(57) ABSTRACT

An electronic device with a plurality of applications available includes a display screen, a sliding portion, a detecting unit, an executing unit. The sliding portion is assembled on the electronic device and is slidable on the surface of the display screen. The detecting unit detects the position of the sliding portion on the surface of the display screen. The executing unit executes different applications according to the different positions to which the sliding portion can be moved.

### BACKGROUND

1. Technical Field

The present disclosure relates to electronic devices, and particularly to an electronic device with a display screen.

2. Description of Related Art

Electronic devices with a touch display screen commonly include a menu having a plurality of options, and each option corresponds to a particular application. When executing an application, the user has to find and click a corresponding option. However, the option is displayed as a small icon, and it takes time to find the small icon, and when clicking the icon by operating a hotkey(s), other options may be activated by mistake.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a plan view of an electronic device in accordance with one embodiment.

FIG. 2 is a block diagram of the electronic device of FIG. 1.

FIG. 3 is a flowchart of a switching method in accordance with the one embodiment of FIG. 1.

### DETAILED DESCRIPTION

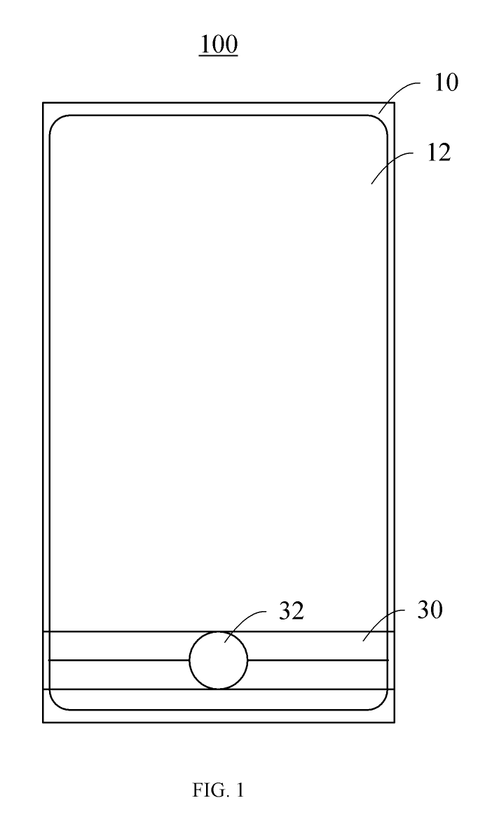

Referring to FIG. 1, an electronic device 100 includes a main body 10, a display screen 12 disposed on the main body 10, and a sliding portion 30 assembled on the main body 10 which can slide up and down the display screen 12. The electronic device 100 can detect the position of the sliding portion 30 on the display screen 12 and execute different applications according to the position of the sliding portion 30. In the embodiment, the electronic device 100 is a mobile phone. In another embodiment, the electronic device 100 can be a PDA, a video player, or the like.

The main body 10 is substantially rectangular, and includes a processor, a memory, a battery, and other components (none of which are shown) for executing different applications of the electronic device 100. When one of the applications has been selected, the display screen 12 displays different regions corresponding to the executed application. For example, when a “send message” application is executed, the display screen 12 displays an editing region for displaying the message being input and a key region for displaying relevant virtual keys.

The display screen 12 is substantially rectangular and is mounted on a surface of the main body 10. The display screen 12 is used for displaying information, such as menus.

The sliding portion 30 can slide on the surface of the display screen 12. The sliding portion 30 includes at least one button 32. When the button 32 is pressed, signals are transmitted to the main body 10 in a wireless or a wired manner. In the embodiment, the sliding portion 30 is parallel with the bottom edge of the main body 10 and slides up and down the display screen 12. The button 32 is a joystick button.

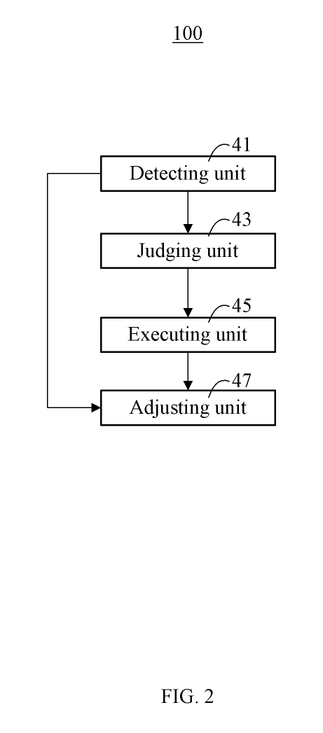

Referring to FIG. 2, the electronic device 100 further includes a detecting unit 41, a judging unit 43, an executing unit 45, and an adjusting unit 47.

The detecting unit 41 is used for detecting the position of the sliding portion 30 on the display screen 12 and generating positional information. In the embodiment, the detecting unit 41 may be an infrared sensor arranged at one of the long sidewalls of the main body 10. The positional information includes the coordinates of the sliding portion 30 relative to the display screen 12.

The judging unit 43 defines a plurality of predetermined positional ranges into which the sliding portion 30 can be moved. The predetermined positional ranges are different from each other. The judging unit 43 is used for judging whether the position of the sliding portion 30 is within one of the predetermined positional ranges and generating a signal corresponding to a particular function if the position of the sliding portion 30 is within one of the predetermined positional ranges. In the embodiment, the judging unit 43 defines a first predetermined positional range and a second predetermined positional range. If the position of the sliding portion 30 is determined to be within the first predetermined positional range, the judging unit 43 generates a first function signal. If the position of the sliding portion 30 is determined to be within the second predetermined positional range, the judging unit 43 generates a second function signal.

The executing unit 45 is used for executing an application which corresponds to the function signal. In the embodiment, the executing unit 45 executes a first application (for example, editing a message) in response to the first function signal, and executes a second application (for example, playing music) in response to the second function signal. When any function signal is executed, the executing unit 45 controls the display screen 12 to display a first region and a second region, respectively arranged on the opposite sides of the sliding portion 30, in which the executed application, or parts of the executed application, can run. When the first application is executed, the first region displays the message which has been input and the second region displays virtual keys by which commands can be entered. When the second application is executed, the first region plays or displays audio or video and the second region displays the virtual keys to control playback.

The adjusting unit 47 is used for adjusting ratio of the areas of the first region to the second region according to the positional information. Each position of the sliding portion 30 corresponds to a particular ratio of the areas of the first region to the second region. The relationship of the positional information and the corresponding ratio is saved in a table in the electronic device 100. For example, when the first application (editing the message) is executed, the adjusting unit 47 adjusts the ratio as between the region for displaying the input message and the virtual key region, according to the positional information of the sliding portion 30.

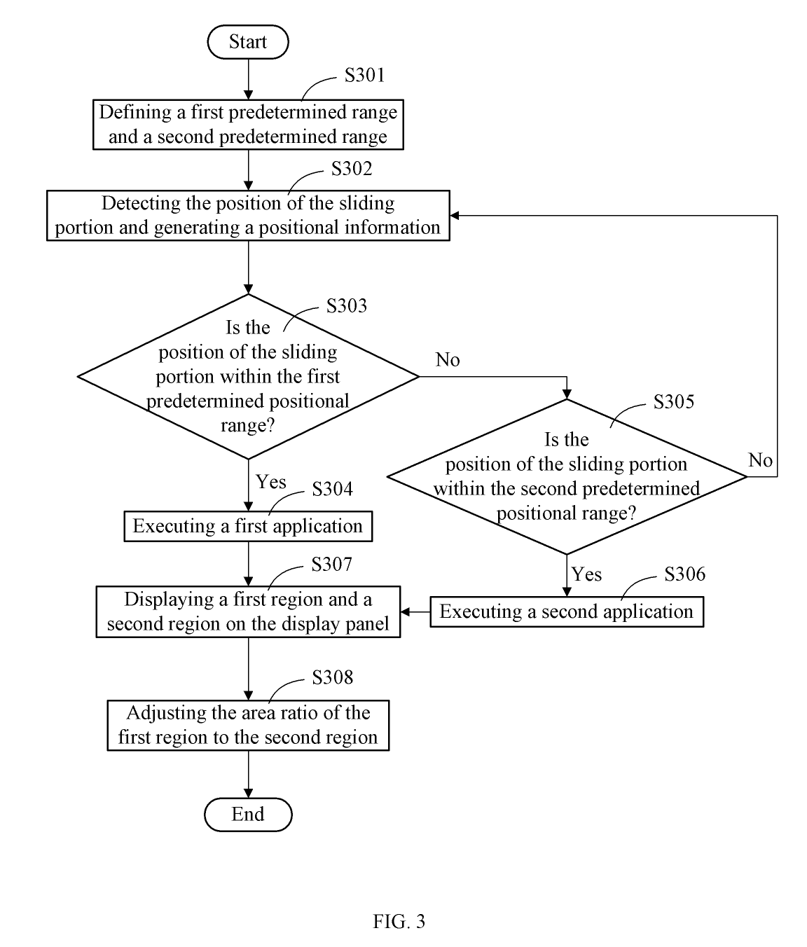

Referring to FIG. 3, a switching method is used for switching between the different applications of an electronic device 100. The electronic device 100 includes a main body 10, a display screen 12 disposed on the main body 10 and a sliding portion 30 assembled on the main body 10 and which can slide up and down the display screen 12. The switching method includes the following steps.

In step S301, the judging unit 43 defines a first predetermined positional range of positions and a second predetermined positional range of positions.

In step S302, the detecting unit 41 detects the position of the sliding portion 30 and generates positional information. In the embodiment, the detecting unit 41 is an infrared sensor. The positional information includes the coordinates of the sliding portion 30 relative to the display screen 12.

In step S303, the judging unit 43 further judges whether the position of the sliding portion 30 is within the first predetermined positional range. If the position of the sliding portion 30 is within the first predetermined positional range, generating a first function signal and step S304 is implemented. If the position of the sliding portion 30 is outside the first predetermined positional range, step S305 is implemented.

In step S304, the executing unit 45 executes a first application in response to the first function signal and step S307 is implemented. In the embodiment, the first application is used for editing a message.

In step S305, the judging unit 43 judges whether the position of the sliding portion 30 is within the second predetermined positional range. If the position of the sliding portion 30 is within the second predetermined positional range, generating a second function signal and step S306 is implemented. If the position of the sliding portion 30 is outside the second predetermined positional range, the process returns to the step S302. In the embodiment, the second predetermined positional range is different from the first predetermined positional range and different from any other positional range.

In step S306, the executing unit 45 executes a second application in response to the second function signal and step S307 is implemented. In the embodiment, the second application is used for playing or displaying audio or video.

In step S307, the executing unit 45 controls the display screen 12 to display a first region and a second region respectively arranged on the opposite sides of the sliding portion 30.

In step S308, the adjusting unit 47 adjusts the ratio of the areas of the first region to the second region according to the positional information of the sliding portion 30. In the embodiment, each positional information of the sliding portion 30 corresponds to a particular ratio of the areas as between the first region and the second region. The relationship of the positional information and the corresponding ratio is saved in a table in the electronic device 100.

As described, the electronic device 100 can execute an application by sliding the sliding portion 30 to within the corresponding predetermined positional range of positions on the display screen 12, and further can adjust the ratio of the display area of the first region to the display area of the second region according to the particular position of the sliding portion 30.

It is to be understood, however, that even though information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device with a plurality of applications, comprising:
a display screen;
a sliding portion assembled on the electronic device and slidable on the surface of the display screen;
a detecting unit adapted to detecting the position of the sliding portion on the display screen; and
an executing unit adapted to execute different applications in response to the different positions of the sliding portion on the display screen.

2. The electronic device of claim 1, further comprising an adjusting unit, wherein the detecting unit further generates a positional information according to the position of the sliding portion, the executing unit further controls the display screen to display a first region and a second region different from the first region, the adjusting unit adjusts the ratio of the first region to the second region according to the positional information.

3. The electronic device of claim 2, wherein the first region and the second region are respectively arranged on the opposite sides of the sliding portion.

4. The electronic device of claim 2, wherein each of the positional information corresponds to a particular ratio of the first region to the second region.

5. The electronic device of claim 1, further comprising a judging unit, wherein the judging unit defines a plurality of predetermined positional ranges, the judging unit judges whether the position of the sliding portion is within one of the predetermined positional ranges and generating a corresponding function signal if the position of the sliding portion is within one of the predetermined positional ranges, the executing unit executes a corresponding application in response to the function signal.

6. The electronic device of claim 5, wherein the judging unit defines a first predetermined positional range and a second predetermined positional range, the first predetermined positional range is different from the second predetermined positional range.

7. The electronic device of claim 6, wherein if the position of the sliding portion is within the first predetermined positional range, the judging unit generates a first function signal, the executing unit executes a first application in response to the first function signal, the first application is used for editing messages.

8. The electronic device of claim 6, wherein if the position of the sliding portion is within the second predetermined positional range, the judging unit generates a second function signal, the executing unit executes a second application in response to the second function signal, the second application is used for displaying audio/video.

9. The electronic device of claim 1, wherein the detecting unit is an infrared sensor.

10. A switching method for an electronic device with a plurality of applications, the electronic device comprising a display screen, wherein the electronic device further comprises a sliding portion assembled on the electronic device and slidable relative to the display screen, the switching method comprising:
detecting the position of the sliding portion on the display screen and generating a positional information; and
executing different applications according to the different positions of the sliding portion.

11. The switching method of claim 10, wherein after detecting the position of the sliding portion on the display screen and generating positional information further comprising:
judging whether the position of the sliding portion is within a first predetermined positional range;
if the position of the sliding portion is within the first predetermined positional range, generating a first function signal; and
executing a first application in response to the first function signal.

12. The switching method of claim 11, wherein the first application is used for editing messages.

13. The switching method of claim 11, wherein if the position of the sliding portion is not within the first predetermined positional range, judging whether the position of the sliding portion is within a second predetermined positional range;
if the position of the sliding portion is within the second predetermined positional range, generating a second function signal; and
executing a second application in response to the second function signal.

14. The switching method of claim 13, wherein the second application is used for displaying audio/video.

15. The switching method of claim 13, wherein the first predetermined positional range is different from the second predetermined positional range.

16. The switching method of claim 10, wherein after executing different applications according to the different position of the sliding portion further comprising:
forming a first region and a second region on the display screen; and
adjusting the ratio of the first region to the second region according to the positional information.

17. The switching method of claim 16, wherein the first region and the second region are respectively arranged on the opposite sides of the sliding portion.

18. The switching method of claim 10, wherein the electronic device using an infrared sensor to detect the position of the sliding portion on the display screen.
